(19) United States
(12) Patent Application Publication
(10) Pub. No.: US 2018/0070612 A1
(43) Pub. Date: Mar. 15, 2018

(54) RUMEN BY-PASS ANIMAL FEED COMPOSITION AND METHOD OF MAKING SAME

(71) Applicants: Feng Wan, Issaquah, WA (US); Timothy Martin Londergan, Seattle, WA (US); BENEMILK OY, Rasio (FI)

(72) Inventors: Feng Wan, Issaquah, WA (US); Merja Birgitta Holma, Raisio (FI); Ilmo Pellervo Aronen, Hinnerjoki (FI); Timothy Martin Londergan, Seattle, WA (US); James Edward Nocek, Auburn, NY (US)

(21) Appl. No.: 15/560,467

(22) PCT Filed: Mar. 25, 2016
(86) PCT No.: PCT/US16/24298

§ 371 Date: Sep. 21, 2017

Related U.S. Application Data
(60) Provisional application No. 62/138,204, filed on Mar. 25, 2015.
(60) Provisional application No. 62/214,628, filed on Sep. 4, 2015.

(51) Int. Cl. A23K 20/158; A23K 20/142; A23K 20/174; A23K 50/10; A23K 40/35; A23K 40/10

(52) U.S. Cl. CPC A23K 20/158; A23K 20/142; A23K 40/10; A23K 50/10; A23K 40/35; A23K 20/174

(57) ABSTRACT

A rumen by-pass composition comprises a first rumen by-pass component and a nutritional composition, wherein the first rumen by-pass component comprises a first fatty acid composition having a melting point not less than 40° C. and an Iodine Value not greater than 30.

### CROSS-REFERENCE TO RELATED APPLICATIONS

This application claims the benefit of U.S. provisional application Nos. 62/138204, filed on Mar. 25, 2015, and 62/214628, filed on Sep. 4, 2015, both expressly incorporated herein by reference.

### BACKGROUND

Increasing production and solids content of milk obtained from lactating ruminants have been major goals for dairy farmers. Additional milk or milk solids production is beneficial because it results in a higher yield, thereby increasing profits. Increased milk fat, protein or both are desirable because milk solids have a higher economic value and can be used in highly desirable food products, such as cheese, yogurt, and the like.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a rumen by-pass composition comprises a first rumen by-pass component and a nutritional composition, wherein the first rumen by-pass component comprises a first fatty acid composition having a melting point not less than 40° C. and an Iodine Value not greater than 30.

In some embodiments, the nutritional composition is configured to substantially bypass rumen when administered to a ruminant.

In some embodiments, the first rumen by-pass component is configured to protect the nutritional composition from rumen bacterial metabolism.

In some embodiments, the rumen by-pass composition is formed as solid particles.

In some embodiments, the first rumen by-pass component and the nutritional composition form a homogeneous mixture.

In some embodiments, the first rumen by-pass component and the nutritional composition form a heterogeneous mixture.

In some embodiments, the first rumen by-pass component at least partially encapsulates the nutritional composition.

In some embodiments, the first rumen by-pass component has a melting point not less than 50° C.

In some embodiments, the first rumen by-pass component further comprises a wax.

In some embodiments, the first rumen by-pass component further comprises a polymer.

In some embodiments, the rumen by-pass composition further comprises a filler, an antistatic agent, a plasticizers, a colorant, an appetite stimulants, a flavoring agent, a surfactant, or a combination thereof.

In some embodiments, the filler comprises a feed ingredient.

In some embodiments, the first fatty acid composition has a melting point from about 54° C. to about 200° C.

In some embodiments, the first fatty acid composition has an Iodine value from about 0.5 to about 6.

In some embodiments, the first fatty acid composition has unsaponifiable matter no greater than 1.5% by weight.

In some embodiments, the first fatty acid composition comprises a palmitic acid compound.

In some embodiments, the first fatty acid composition comprises at least 98% of free palmitic acid by weight.

In some embodiments, the first fatty acid composition comprises a stearic acid compound.

In some embodiments, the first fatty acid composition consists essentially free palmitic acid, free stearic acid, or a combination thereof.

In some embodiments, the rumen by-pass composition further comprises a second rumen by-pass component.

In some embodiments, the second rumen by-pass component comprises a second fatty acid composition having a melting point not less than 40° C. and an Iodine Value not greater than 10.

In some embodiments, the first rumen by-pass component and the nutritional composition form a first rumen by-pass mixture, and wherein the second rumen by-pass component at least partially encapsulates the first rumen by-pass mixture.

In some embodiments, the rumen by-pass composition has a core component and a shell component at least partially encapsulating the core component, wherein the core component comprises the nutritional composition; and wherein the shell component comprises the first rumen by-pass component.

In some embodiments, the rumen by-pass composition has a first core component, a first shell component at least partially encapsulating the first core component to provide a second core component, and a second shell component at least partially encapsulating the second core component, wherein the first core component comprises the nutritional composition; wherein the first shell component comprises the first rumen by-pass component; and wherein the second shell component comprises the second rumen-by pass component.

In some embodiments, the nutritional composition comprises an amino acid compound, a lipid, a vitamin, a trace element, a mineral, a glucogenic precursor, an antioxidant, a prebiotic agent, a probiotic agent, an antimicrobial agent, an enzyme, a choline derivative, a feed ingredient, a carrier, a binding agent, a bulking agent, or a combination thereof.

In some embodiments, the amino acid compound comprises leucine, lysine, histidine, valine, arginine, threonine, isoleucine, phenylalanine, methionine, tryptophan, carnitine, alanine, asparagine, lysine, aspartic acid, cysteine, glutamic acid, glutamine, glycine, valine, ornithine, proline, selenocysteine, selenomethionine, serine, tyrosine, its derivative or precursor thereof.

In some embodiments, the amino acid compound comprises a methionine compound or a lysine compound.

In some embodiments, the methionine compound comprises methionine, methionine HCl salt, methionine HBr salt, methionine HI salt, N-steroyl-methionine, Oleoyl-methionine, capryl-capryolic methionine, methionine ethyl ester, methionyl DL-methionine, N-t-butyloxycarbonyl-L-methionine-do-cyclohexyl ammonium salt, N-t-butyloxycarbonyl-L-methionine-p-nitrophenyl ester, N-propionyl-DL-methionine, N-carbobenzoxy-DL-methionine, 3-benzoyloxydihydro-2(3H)thiophenone, glycyl-DL-methionine, N-acetyl-DL-methionine, N-formyl-DL-methionine poly-L-methionine, methionine hydroxyl analog methyl ester, 3-hydroxydihydro-2(3H)thiophenone, phenyl-r-methyl mercapto-a-hydroxybutyrate, methionine sulfoxide, DL-methionine amide HCl, DL-methionine sulfone, DL-methionine methyl ester HCl, DK-2-ureido-4-methylthiobutyric acid, N-acetyl-DL-homocysteine thiolactone, N-formyl-DL-methionine, DL-methione, N-benzoyl-DL-methionine amide, N-benzoyl-DL-methionine methyl ester, DL-methionine methyl sulfonium chloride, DL-homocysteine, N-octanoyl-DL-methionine, N-lauryl-DL-methionine, N-lauryl-DL-homocysteine thiolactone, N-benzoyl-DL-homocysteine thiolactone, N-lauryl-DL-methionine methyl ester, DL-homocysteine thiolactone hydrochloride, N-hydroxylmethyl-DL-methionine Ca, and a derivative thereof.

In some embodiments, the lysine compound comprises lysine, lysine HCl salt, lysine HBr salt, lysine HI salt, dyhydroxymethyl-L-lysine-Ca, polylysine, or a derivative thereof.

In some embodiments, the lipid comprises one or more oils, fats, esters, monoglycerides, diglycerides, triglycerides, or free fatty acids.

In some embodiments, the lipid comprises an essential fatty acid.

In some embodiments, the lipid comprises essentially conjugated linoleic acid.

In some embodiments, the lipid comprises alpha-linolenic acid, an omega-3 fatty acid, or an omega-6 fatty acid.

In some embodiments, the lipid comprises oleic acid or an oleic derivative.

In some embodiments, the oleic derivative comprises an oleic acid ester, a high oleic oil, or a combination thereof.

In some embodiments, the high oleic oil comprises at least 40% by weight of oleic content.

In some embodiments, the vitamin comprises vitamin A, vitamin B, vitamin C, vitamin D, vitamin H, vitamin E, vitamin K, or its derivative thereof.

In some embodiments, the choline derivative comprises choline, choline chloride, choline bi-tartrate, di-hydrogenated citrate of choline, bicarbonate of choline, choline sulphate, choline hydroxide, or a combination thereof.

In some embodiments, he rumen by-pass composition further comprises a surfactant component.

In some embodiments, the surfactant component comprises a non-ionic emulsifier.

In some embodiments, the surfactant component comprises an ionic emulsifier.

In some embodiments, the surfactant component comprises an emulsifier having a hydrophilic-lipophilic balance value of about 5 to about 25.

In some embodiments, the surfactant component comprises polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids polyglycerol polyricinoleate, propane-1,2-diol esters of fatty acids, thermally oxidised soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, or derivatives thereof.

In some embodiments, the surfactant component comprises a surfactant derived from oleic acid.

In some embodiments, the surfactant component comprises sodium oleate, potassium oleate, calcium oleate, ammonium oleate, sorbitan oleate, sorbitan trioleate, glyceryl oleate, methyl oleate, ethyl oleate, PEG oleate, triethanolamine oleate (TEA oleate), polysorbitan oleate, polysorbate 20, polysorbate 40, polysorbate 60, polysorbate 80, or a combination thereof.

In some embodiments, a dietary composition for ruminants comprises the rumen by-pass composition and a feed ingredient.

In some embodiments, dietary composition is formed as a mash mixture, granules, particles, or pellets.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a diagrammatical illustration of an embodiment of a rumen by-pass composition;

FIG. 1B is a diagrammatical illustration of an embodiment of a rumen by-pass composition;

FIG. 1C is a diagrammatical illustration of an embodiment of a rumen by-pass composition;

FIG. 1D is a diagrammatical illustration of an embodiment of a rumen by-pass composition;

FIG. 2 is a schematic illustration of a method and a system for making a rumen-by pass composition;

FIG. 3 is a schematic illustration of a method and a system for making a rumen-by pass composition;

FIG. 4 is a schematic illustration of a method and a system for making a rumen by-pass composition.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art.

The following terms shall have, for the purposes of this application, the respective meanings set forth below.

A “ruminant” is generally a suborder of mammal with a multiple chamber stomach that gives the animal the ability to digest cellulose-based food by softening it within a first chamber (rumen) of the stomach and to regurgitate the semi-digested mass to be chewed again by the ruminant for digestion in one or more other chambers of the stomach. Examples of ruminants include, but are not limited to, lactating animals such as cattle, goats and sheep. Cattle may include dairy cows, which are generally animals of the species Bos taurus. The milk produced by ruminants is widely used in a variety of dairy-based products.

The present disclosure generally relates to fatty acid compositions, ruminant feed mixtures, the dietary compositions made therefrom, and to the methods for making the dietary compositions that can be fed to ruminants. The dietary compositions may be configured to improve various aspects of milk production in the ruminants. For instance, some embodiments provide that the dietary compositions may increase the amount of milk production by the ruminant, increase the fat content of the milk produced by the ruminant, increase the protein content of the milk produced by the ruminant, or all three. Specific compositions described herein may include ruminant feed mixtures, supplements, or the like. According to some embodiments, the dietary compositions may include liquids, solids or combinations thereof, such as dry particles, pellets, liquid suspensions, emulsions, slurries, pastes, gels, or the like.

When a ruminant consumes feed, the nutrients such as fat, amino acids, and vitamins etc. in the feed may be degraded or modified by the rumen microbes. This may cause several potential undesirable effects: first, nutrients that are not inert in the rumen may not reach the lower digestive tract and therefore become unavailable to the ruminant; second, the nutrients that are not inert in the rumen may have a negative effect on rumen digestion and health and therefore may decrease feed intake and decrease rumen digestibility of the feed; and, third, the metabolite from the rumen metabolism of some nutrients may negatively affect milk production.

For example, feeding of vegetable oils can have negative effects on both rumen function and milk formation. The ruminal microbes may convert unsaturated fats to saturated fats in a sequence of events called biohydrogenation. It has been hypothesized that this act of biohydrogenation by bacteria is an attempt to protect themselves, as unsaturated fats can be toxic to bacteria, primarily the bacteria that digest fiber. If the feeding of unsaturated fats reduces the numbers or activity of fiber-digesting bacteria in the rumen, then feed intake may decrease, milk production may decrease, and milk fat concentration may decrease.

During the process of biohydrogenation of unsaturated fats in the rumen, the conversion to the saturated state may be incomplete. This may result in the synthesis of several forms (isomers) of fatty acids including the trans fatty acids such as the trans-10, cis-12 conjugated linoleic acid (CLA) and the trans-10 C18:1. These trans fatty acids may negatively impact milk fat synthesis when they leave the rumen, are absorbed into the blood stream, and are taken up by the mammary gland. As a result, the milk fat concentration may decrease, and the proportion of trans fatty acids may increase. For example, a high level of polyunsaturated fatty acids in milk can cause taste defects and preservation problems. A typical fatty acid composition of milk fat may contain more than about 70% saturated fatty acids and a total amount of trans fatty acids may be from about 3% to about 10%. When vegetable oil is added into the feed, the proportion of trans fatty acids may rise to more than about 10%.

One solution to diminishing the detrimental effect of oil and fat is to prevent fat biohydrogenation. Fat biohydrogenation can be decreased, for example, by protecting fats from rumen bacteria with formaldehyde-treated casein. Another alternative is to feed the ruminant insoluble fatty acid calcium salts whereby hydrogenation in the rumen can be reduced. However, fatty acid salts typically have a pungent taste that may result in decreased feed intake by the ruminant. In addition, the salts may also disturb certain processes for forming the feed into pellets.

A rumen by-pass composition, described herein, may allow for the transfer of a nutritional agent from via the digestive tract into the blood circulation of a ruminant. This may improve the energy efficiency of milk production and the utilization of energy by the ruminant. When the utilization of energy becomes more effective, milk production, milk solids production, the concentrations of milk protein, the concentration of milk fat, or all of the above may rise. According to some embodiments, the dietary composition may be configured to enhance fat synthesis in the mammary gland by bringing milk fat components to the cell such that energy consuming synthesis in the mammary gland is not necessary. As a result, glucose may be used more efficiently for lactose production causing increased milk production. In addition, the milk protein content may increase because there is no need to produce glucose from amino acids. Accordingly, the ruminant may not lose weight at the beginning of the lactation period, thereby improving the fertility of the ruminant.

In one aspect, the application provides rumen by-pass compositions. In some embodiments, the application provides a rumen by-pass composition, comprising a first rumen by-pass component and a nutritional composition, wherein the first rumen by-pass component comprises a first fatty acid composition having a melting point not less than 40° C. and an Iodine Value not greater than 30.

The nutritional composition is configured to bypass the rumen administered to the ruminant. In some embodiments, from about 40% to about 98% of the nutritional composition by-passes the rumen. In some embodiments, at least 50% of the nutritional composition by-passes the rumen. In some embodiments, at least 60% of the nutritional composition by-passes the rumen. In some embodiments, at least 70%, 80%, 90% of the nutritional composition by-passes the rumen.

The first rumen by-pass component is configured to protect the nutritional composition from rumen bacterial metabolism. In some embodiments, the rumen bacterial metabolism comprises rumen biohydrogenation.

The rumen by-pass composition may be in free flowing solid form. In some embodiments, the ruminant dietary composition may be a dry particle, a pellet, a liquid suspension, a paste, or an emulsion.

In some embodiments, the rumen by-pass composition may be formed as solid particles such as, without limitation, spherical beads, oval beads, flakes, granules, or a combination thereof. The solid particle may have a diameter from about lum to about 20 mm. In some embodiments, the solid particle may have a diameter from about 1 μm to about 3 mm, from about 1 μm to about 10 mm, from about 10 μm to about 2 mm, or from about 100 um to about 4 mm. In some embodiments, the solid particles have an average particle size of about 1 mm, about 2 mm.

The rumen by-pass composition may have a specific density of from about 0.5 to about 2, from about 0.8 to about 1.5. In some embodiments, the rumen by-pass composition may have a specific density of about 1. In some embodiments, the rumen by-pass composition has a specific density equal to or bigger than the specific density of the rumen fluid. In some embodiments, the rumen by-pass composition has a specific density that would facilitate the rumen by-pass composition to pass through the rumen within 2, 4, 6, 8, 12, 24, 36, or 48 hours.

The rumen by-pass composition is a homogeneous mixture or a heterogeneous mixture. In some embodiments, the first rumen by-pass component and the nutritional composition form a homogeneous mixture. In some embodiments, the first rumen by-pass component and the nutritional composition form a heterogenous mixture. In some embodiments, the nutritional composition may be partially encapsulated by the first rumen by-pass component. In some embodiments, the nutritional composition may be wholly encapsulated by the first rumen by-pass component.

The first rumen by-pass component may have a melting point not less than 50° C., 60° C., 70° C., 80° C., 90° C., 100° C., 200° C., 300° C. or 400° C. In some embodiments, the first rumen by-pass component may have a melting point from about 50° C. to about 200° C., from about 55° C. to about 100° C., from about 60° C. to about 90° C.

In some embodiments, the first rumen by-pass component may further comprise a wax. The wax may include without limitation a paraffin wax, a natural wax, a synthetic wax, a microcrystalline wax, or a combination thereof. The natural wax may comprise without limitation bee wax, carnauba wax, beeswax, petroleum wax, rice bran wax, castor wax, their derivatives, or a combination thereof.

In some embodiments, the first rumen by-pass component may further comprise a polymer. The polymer may comprise a cross-linked polymer. In some embodiments, the polymer may include without limitation polyurethane, polyester, polystyrene, polypyridine, polyvinylpyridine, polycyante, polyisocynate, polysaccharide, polynucleotide, polyethylene, polyisobutylene, polyvinyl acetate, protein, polysaccharide, or a combination thereof.

In some embodiments, the polymer may comprise a denatured protein. In some embodiments, the polymer may comprise a cross-linked protein. In some embodiments, the protein may be cross-linked by reducing sugars. Representative reducing sugars may include without limitation glucose, lactose, fructose, mannose, maltose, ribose, galactose, their derivatives, or a combination thereof. In some embodiments, the protein may be cross-linked by heat-induced formation of disulfide bonds. In some embodiments, the protein may be cross-linked by disulfide bonds, hydrophobic interactions, ionic interactions, hydrogen bonding, or a combination thereof. In some embodiments, the protein may be cross-linked with a divalent linker, formaldehyde, glutaraldehyde, or other aldehydes.

In some embodiments, the cross-linked polymer may comprise a vegetable oil. The vegetable oil may be a cross-linked vegetable oil. In some embodiments, the cross-linked vegetable oil may be cross-linked through a divalent linker. In some embodiments, the cross-linked vegetable oil may comprise cross-linked corn oil, cross-linked cottonseed oil, cross-linked peanut oil, cross-linked palm kernel oil, cross-linked soybean oil, cross-linked sunflower oil, cross-linked rapeseed oil, or a combination thereof.

In some embodiments, the rumen by-pass composition may further comprise a filler, an antistatic agent, a plasticizers, a colorant, an appetite stimulants, a flavoring agent, a surfactant, or a combination thereof.

In some embodiments, the filler may include a feed ingredient or a mineral. Representative feed ingredients may include without limitation grain, roughage, forage, silage, a protein material, a carbohydrate material, or a combination thereof. In some embodiments, the feed ingredient may include wheat, grains, rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, wheat bran, wheat middlings, wheat mill run, wheat mill run, oat hulls, soya hulls, grass meal, hay meal, alfalfa meal, alfalfa, straw, hay, or a combination thereof.

The antistatic agent may be an oil, a salt or a mineral.

The plasticizer may be starch, silicon dioxide, hydrophilic silica, or a combination thereof.

The flavoring agent may include bubble gum flavor, butter scotch flavor, cinnamon flavor, or a combination thereof. In some embodiments, the flavoring agent may include an essential oil, a plant extract, or a fruit extract. In some embodiments, the flavoring agent may include an aliphatic alcohol, an aromatic alcohol, an ether, a furan ether, a thiazole alcohol, a pyridine ether, a pyridine alcohol, a benzofuran carbonyl compound, an aliphatic ketone, an aromatic ketone, a α-diketone, a pyrrole-α-diketone, an aromatic sulfur compound, a phenol, an phenol ether, an essential oil, or derivatives thereof. In some embodiments, the flavoring agent may include anethole, benzaldehyde, bergamot oil, acetoin, carvol, cinnamaldehyde, citral, ethylvanillin, vanillin, thymol, methyl salicylate, coumarin, anise, cinnamon, ginger, clove, lemon oil, 1-undecanol, 5-dodecalactone, eugenol, geraniol, geranyl acetate, guaiacol, limonene, linalool, piperonal, 2-acetyl-5-methylpyrazine, 2-ethyl-3-methoxypyrazine, 5-methylquinoxaline, 2 methyl-6-propylpyrazine, 2-methylbenzofuran, 2,2′-dithienylmethane, benzyl hexyl carbinol, furfuryl phenyl ether, difurfuryl ether, benzofuran-2-aldehyde, benzothiophene-2-aldehyde, 1-butylpyrrole-2-aldehyde, methyl decyl ketone, dipropyl ketone, ethyl benzyl ketone, 2,6-diacetylpyridine, heptane-3,4-dione, methyl thiophene-2-carboxylate, 2-hydroxyacetophenone, 4-ethyl-2-methoxyphenol, 2-oxobutan-1-ol, or derivatives thereof.

The colorant may be a food or feed grade dye, an antioxidant, a vitamin, a mineral, or a combination thereof. In some embodiments, the colorant may include a flavone, a quinone, a flavanone, an anthracene, a plant extract, a fruit extract, a vitamin, or a combination thereof.

The appetite stimulant may include Vitamin B, Vitamin B6, Vitamin B12, molasses, probiotics, prebiotics, nutritional yeast, or a combination thereof.

In some embodiments, the surfactant component may be a nonionic surfactant or an ionic surfactant. In some embodiments, the surfactant component comprises a non-ionic emulsifier. In some embodiments, the surfactant component comprises an ionic emulsifier. In some embodiments, the surfactant component may comprise an emulsifier having a hydrophilic-lipophilic balance value of about 2 to about 12, about 5 to about 14, about 2 to about 8, or about 6 to about 14. In some embodiments, the surfactant component may comprise an emulsifier having a hydrophilic-lipophilic balance value of not greater than about 10. In some embodiments, the surfactant component comprises an emulsifier having a hydrophilic-lipophilic balance value of about 5 to about 25. In some embodiments, the surfactant component comprises an emulsifier having a hydrophilic-lipophilic balance value of from about 10 to about 20. In some embodiments, the surfactant component comprises an emulsifier having a hydrophilic-lipophilic balance value of at least about 7. In some embodiments, the surfactant component comprises an emulsifier having a hydrophilic-lipophilic balance value of about 15. In some embodiments, the surfactant component may include lecithin, soy lecithin, cephalin, castor oil ethoxylate, sorbitan mono-, di-, or trioleate, polysorbitan mono-, di- or trioleate, tallow ethoxylate, lauric acid, polyethylene glycol, or derivatives thereof. In some embodiments, the surfactant component may include calcium stearoyl dilaciate, glycerol ester, polyglycerol ester, sorbitan ester, polysorbitan ester, polyethylene glycol ester, sugar ester, mono-, di-, or triglyceride, acetylated monoglyceride, lactylated monoglyceride, or derivatives thereof.

In some embodiments, the surfactant component may include castor oil, lecithin, polysorbate, an ammonia solution, butoxyethanol, propylene glycol, ethylene glycol, ethylene glycol polymers, polyethylene, methoxypolyethylene glycol, soy lecithin, cephalin, castor oil ethoxylate, sorbitan monooleate, tallow ethoxylate, lauric acid, polyethylene glycol, calcium stearoyl dilaciate, polyglycerol ester, sorbitan ester, polyethylene glycol ester, sugar ester, monoglyceride, acetylated monoglyceride, lactylated monoglyceride.

In some embodiments, the surfactant component comprises polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids polyglycerol polyricinoleate, propane-1,2-diol esters of fatty acids, thermally oxidised soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, or derivatives thereof. In some embodiments, the sodium or potassium or calcium salts of fatty acids comprises sodium or potassium or calcium salts of distilled palm fatty acids.

In some embodiments, the surfactant component comprises a surfactant derived from oleic acid. In some embodiments, the surfactant component comprises a non-ionic oleate ester derived surfactant. In some embodiments, the surfactant component comprises an ionic oleic acid derived surfactant. In some embodiments, the surfactant component comprises sodium oleate, potassium oleate, calcium oleate, ammonium oleate, sorbitan oleate, sorbitan mono-, di- or trioleate, glyceryl oleate, methyl oleate, ethyl oleate, PEG oleate, triethanolamine oleate (TEA oleate), polysorbitan oleate, polysorbate 80, or a combination thereof.

In some embodiments, the surfactant component may include Tween 20 (polysorbate laurate), Tween 40 (polysorbate 40 palmitate), Tween 60 (polysorbate stearate), Tween 80 (polysorbate oleate), or a combination thereof. In some embodiments, the surfactant may include a bredol surfactant. In some embodiments, the surfactant component may be a liquid surfactant. In some embodiments, the surfactant component may be a solid surfactant.

The surfactant may be present in the first rumen by-pass component in an amount of about 0.01% by weight to about 50.0% by weight. In some embodiment, the weight/weight ratio of the surfactant to the fatty acid component may be about 1:1000 to about 1:5.

In some embodiments, the first rumen by-pass component can have a weight/weight ratio of the surfactant to the fatty acid component is about 1:50 to about 1:20, about 1:100 to about 1:5, about 1:1000 to about 1:2, or about 1:1 to about 1:100. In some embodiments, the ratio may be about 1:10.

The first rumen by-pass component may include no more than 2%, 5%, 15%, 25%, or 30% by weight of the surfactant. In some embodiments, the first rumen by-pass component comprises from about 0.01% to about 25% by weight of the surfactant.

The first fatty acid composition may have a melting point not less than 55° C., 60° C., 70° C., or 80° C. In some embodiments, the first fatty acid composition may have a melting point from about 54° C. to about 200° C. or from about 55° C. to about 80° C.

The first fatty acid composition may have an Iodine Value not greater than 0.5, 1, 2, 5, 6, 7, or 10. In some embodiments, the first fatty acid composition may have an Iodine value from about 0.5 to about 6. In some embodiments, the first fatty acid composition of may have an Iodine value from about 0.5 to about 2.

In some embodiments, the first fatty acid composition may have a moisture level of not greater than 1%, 2%, 3% or 5% by weight. In some embodiments, the first fatty acid composition may have a moisture level of not greater than 0.01%.

In some embodiments, the first fatty acid composition may have unsaponifiable matter no greater than 0.5%, 1%, 1.5%, 2%, 3%, 5%, or 10% by weight. In some embodiments, the first fatty acid composition may have unsaponifiable matter not greater than 2% by weight.

In some embodiments, the first fatty acid composition may include a palmitic acid compound. In some embodiments, the first fatty acid composition may include at least about 98%, 97%, 95%, 94%, 92%, 90%, 85% or 80% of a palmitic acid compound by weight. The palmitic acid compound may include free palmitic acid, a palmitic acid derivative, or both. In some embodiments, the first fatty acid composition may include at least 98% of free palmitic acid by weight. The palmitic acid derivative may include a palmitic acid ester, a palmitic acid amide, a palmitic acid salt, a palmitic acid carbonate, a palmitic acid carbamates, a palmitic acid imide, a palmitic acid anhydride, or a combination thereof.

In some embodiments, the first fatty acid composition may include a stearic acid compound. The stearic acid compound may include free stearic acid, a stearic acid derivative, or both the stearic acid derivative may include a stearic acid ester, a stearic acid amide, a stearic acid salt, a stearic acid carbonate, a stearic acid carbamates, a stearic acid imide, a stearic acid anhydride, or a combination thereof.

In some embodiments, the first fatty acid composition may consist essentially of a palmitic acid compound, a stearic acid compound, or a combination thereof. In some embodiments, the first fatty acid composition may consist essentially of free palmitic acid and free stearic acid. In some embodiments, the first fatty acid composition may consist essentially of free palmitic acid and free stearic acid having a weight/weight ratio from about 10:1 to about 1:10. In some embodiments, the first fatty acid composition may comprise a palmitic acid compound, a stearic acid compound, or a combination thereof. In some embodiments, the first fatty acid composition may comprise free palmitic acid and free stearic acid. In some embodiments, the first fatty acid composition may comprise free palmitic acid and free stearic acid having a weight/weight ratio from about 10:1 to about 1:10. In some embodiments, the ratio of free palmitic acid and free stearic acid is about 4:6 w/w, about 7:3 w/w, about 1:1 w/w or about 9:1 w/w. In some embodiments, the ratio of free palmitic acid and free stearic acid is about 6:4 to about 4:6. In some embodiments, the ratio of free palmitic acid and free stearic acid is about 8:2 to about 2:8.

In some embodiments, the ratio of the nutritional composition and free palmitic acid in the first fatty acid composition is about 75:440 w/w. In some embodiments, the ratio of the nutritional composition and free palmitic acid is about 95/500 w/w. In some embodiments, the ratio of the nutritional composition and free palmitic acid is from about 1:20 w/w to about 1:1 w/w.

In some embodiments, the ratio of nutritional composition and free stearic acid in the first fatty acid composition is from about 1:50 w/w to about 1:1 w/w. In some embodiments, the ratio of the nutritional composition and the first rumen by-pass component is from about 1:100 w/w to about 1:1 w/w.

In some embodiments, the rumen by-pass composition may further include a second rumen by-pass component. In some embodiments, the second rumen by-pass component may include a second fatty acid composition having a melting point not less than 40° C. and an Iodine Value not greater than 10. In some embodiments, the second rumen by-pass component is substantially similar to the first rumen by-pass component. In some embodiments, the second fatty acid composition is substantially similar to the first fatty acid composition. The second rumen by-pass component can be any of the rumen by-pass components described for the first rumen by-pass component. The second fatty acid composition can be any of the fatty acid compositions described for the first fatty acid composition.

In some embodiments, the first rumen by-pass component and the nutritional composition may form a first rumen by-pass mixture, and the second rumen by-pass component may encapsulate at least partially (or wholly) the first rumen by-pass mixture. In some embodiments, the first rumen by-pass component may encapsulate the nutritional composition. In some embodiments, the first rumen by-pass mixture may be heterogeneous. In some embodiments, the first rumen by-pass mixture may be homogeneous.

In some embodiments, the rumen by-pass composition may have a core-shell structure. In some embodiments, the composition may have a core component and a shell component encapsulating partially or wholly the core component, wherein the core component comprises the nutritional composition; and wherein the shell component comprises the first rumen by-pass component. In some embodiments, the rumen by-pass composition may have a first core component, a first shell component at least partially encapsulating the first core component to provide a second core component, and a second shell component at least partially (or wholly) encapsulating the second core component, wherein the first core component comprises the nutritional composition; wherein the first shell component comprises the first rumen by-pass component; and wherein the second shell component comprises the second rumen-by pass component.

In some embodiments, the nutritional composition may include an amino acid, a lipid, a vitamin, a trace element, a mineral, a glucogenic precursor, an antioxidant, a prebiotic agent, a probiotic agent, an antimicrobial agent, an enzyme, a choline derivative, a feed ingredient, a carrier, an energy source, a protein material, a binding agent, a bulking agent, beta-carotene or its derivatives, and a filler, or a combination thereof.

The amino acid may be any essential or non essential amino acids and their derivatives including for example leucine, lysine, histidine, valine, arginine, threonine, isoleucine, phenylalanine, methionine, tryptophan, carnitine, alanine, asparagine, lysine, aspartic acid, cysteine, glutamic acid, glutamine, glycine, valine, ornithine, proline, selenocysteine, selenomethionine, serine, tyrosine, its derivative or precursor thereof.

The amino acid may be metal chelated amino acids. In some embodiments, the amino acid may be an amino acid chelated or glycinated with mineral or selenium yeast. For example, the amino acid may be chelated with Zn, Fe , Ca, Se or Cobalt. In some embodiments, the amino acid comprises a methionine compound or a lysine compound. In some embodiments, the methionine compound comprises methionine, methionine HCl salt, methionine HBr salt, methionine HI salt, N-steroyl-methionine, Oleoyl-methionine, capryl-capryolic methionine, methionine ethyl ester, methionyl DL-methionine, N-t-butyloxycarbonyl-L-methionine-do-cyclohexyl ammonium salt, N-t-butyloxycarbonyl-L-methionine-p-nitrophenyl ester, N-propionyl-DL-methionine, N-carbobenzoxy-DL-methionine, 3-benzoyloxydihydro-2(3H)thiophenone, glycyl-DL-methionine, N-acetyl-DL-methionine, N-formyl-DL-methionine poly-L-methionine, methionine hydroxyl analog methyl ester, 3-hydroxydihydro-2(3H)thiophenone, phenyl-r-methyl mercapto-a-hydroxybutyrate, methionine sulfoxide, DL-methionine amide HCl, DL-methionine sulfone, DL-methionine methyl ester HCl, DK-2-ureido-4-methylthiobutyric acid, N-acetyl-DL-homocysteine thiolactone, N-formyl-DL-methionine, DL-methione, N-benzoyl-DL-methionine amide, N-benzoyl-DL-methionine methyl ester, DL-methionine methyl sulfonium chloride, DL-homocysteine, N-octanoyl-DL-methionine, N-lauryl-DL-methionine, N-lauryl-DL-homocysteine thiolactone, N-benzoyl-DL-homocysteine thiolactone, N-lauryl-DL-methionine methyl ester, DL-homocysteine thiolactone hydrochloride, N-hydroxylmethyl-DL-methionine Ca, and a derivative thereof. In some embodiments, the lysine compound comprises lysine, lysine HCl salt, lysine HBr salt, lysine HI salt, dyhydroxymethyl-L-lysine-Ca, polylysine, or a derivative thereof.

In some embodiments, the nutritional composition may consist essentially of an amino acid or its derivative thereof. In some embodiments, the nutritional composition may comprise of an amino acid or its derivative thereof. The amino acid may be selected from carnitine, histidine, alanine, isoleucine, arginine, leucine, asparagine, lysine, aspartic acid, methionine, cysteine, phenylalanine, glutamic acid, threonine, glutamine, tryptophan, glycine, valine, ornithine, proline, selenocysteine, selenomethionine, serine, tyrosine, or derivatives thereof.

In some embodiments, the nutritional composition may consist essentially of essential amino acids or their derivatives. In some embodiments, the nutritional composition may comprise of essential amino acids or their derivatives. Example essential amino acids include for example methionine, a methionine derivative, 2-hydroxy-4-methylthio butanoic acid (HMTBa), a HMTBa derivative, lysine, a lysine derivative, or a combination thereof.

In some embodiments, the nutritional composition may consist essentially of methionine or its derivatives. In some embodiments, the nutritional composition may comprise of methionine or its derivatives. The methionine derivative may be selected from an ester, a thioester, a disulfide derivative, an ether, a thioether, an amide, an imide, a salt, a metal chelated methionine derivative, or a combination thereof. The metal chelated methionine derivative may include a methionine chelated with a metal selected from calcium, sodium, magnesium, phosphorous, potassium, manganese, zinc, selenium, copper, iodine, iron, cobalt, or molybdenum, or a combination thereof.

In some embodiments, the rumen by-pass composition may consist essentially of lysine or its derivatives. In some embodiments, the rumen by-pass composition may comprise of lysine or its derivatives. The lysine derivative may be selected from an ester, an amide, an imide, a salt, a metal chelated lysine derivative, or a combination thereof. The metal chelated lysine derivative comprises a lysine chelated with a metal selected from calcium, sodium, magnesium, phosphorous, potassium, manganese, zinc, selenium, copper, iodine, iron, cobalt, or molybdenum, or a combination thereof.

In some embodiments, the rumen by-pass composition consists essentially of methionine or its derivative and lysine or its derivative. In some embodiments, the rumen by-pass composition comprises methionine or its derivative and lysine or its derivative. In some embodiments, the ratio of methionine or its derivative and lysine or its derivative is from about 1:6 to about 1:2. In some embodiments, the ratio of methionine or its derivative and lysine or its derivative is from about 2:5 to about 2:1.

The lipid may include one or more oils, fats, monoglycerides, diglycerides, triglycerides, or free fatty acids. In some embodiments, the nutritional composition may consist essentially of the lipid. In some embodiments, the nutritional composition may comprise a lipid. In some embodiments, the lipid comprises an essential fatty acid. In some embodiments, the lipid comprises essentially conjugated linoleic acid. In some embodiments, the lipid comprises alpha-linolenic acid, an omega-3 fatty acid, or an omega-6 fatty acid. In some embodiments, the nutritional composition may consist essentially of conjugated linoleic acid. In some embodiments, the nutritional composition may comprise conjugated linoleic acid. In some embodiments, the rumen by-pass composition may include the lipid comprising from about 5% to about 50% conjugated linoleic acid. In some embodiments, the lipid comprises at least 25% conjugated linoleic acid.

The conjugated linoleic acid compound may include any conjugated linoleic acid isomers. Example conjugated linoleic acid isomers may include trans-10, cis-12 conjugated linoleic acid, cis-8, trans-10 conjugated linoleic acid, trans-8, cis-10 conjugated linoleic acid, a conjugated linoleic acid compound comprising a double bond including carbon number 10, or a mixture comprising at least two of the above compounds.

In some embodiments, the lipid may include corn oil, poppy seed oil, fish oil, cotton seed oil, soybean oil, walnut oil, safflower oil, sunflower oil, sesame oil, rapeseed oil, linseed oil or a combination thereof. In some embodiments, the lipid may include a vegetable oil selected from the group consisting of vegetable oils containing at least 50% C18:2 and at least 30% C18:3. In some embodiments, the lipid may include fatty acids selected from the group consisting of oleic acid, conjugated linoleic acid, linolenic acid, phytanic acid, omega 3 fatty acids, docosahexaenoic acid, eicosapentaenoic acid, their derivatives, or a combination thereof.

In some embodiments, the lipid may include one or more oils, fats, monoglycerides, diglycerides, triglycerides, free fatty acids, oleic acid, conjugated linoleic acid, linolenic acid, phytanic acid, omega 3 fatty acids, C22:6 fatty acids, eicospentaenoic acid (C20:5), corn oil, poppy seed oil, fish oil, cotton seed oil, peanut oil, palm oil, marine lipids, soybean oil, walnut oil, safflower oil, sunflower oil, sesame oil, rapeseed oil or linseed oil. In some embodiments, the lipid comprises an omega-3 fatty acid. In some embodiments, the lipid comprises an omega-6 fatty acid. In some embodiments, the lipid comprises oleic acid or an oleic derivative. In some embodiments, the oleic derivative comprises an oleic acid ester, mono-, a high oleic oil, or a combination thereof. In some embodiments, the high oleic oil comprises at least 40% by weight of oleic content. In some embodiments, the high oleic oil comprises not less than 50% by weight of oleic content. In some embodiments, the high oleic oil comprises not less than 60% by weight of oleic content. The lipid has a weight percentage from about 2% to about 50% of the rumen by-pass composition. In some embodiments, the lipid has a weight percentage from about 5% to about 20% of the rumen by-pass composition.

The prebiotic agent may include fructo-oligosaccahrides, inulin, galacto-oligosaccahride, mannan-oligosaccahride, beta-glycan, a yeast, a yeast derivative, a component of a yeast, a yeast extract, or a combination thereof. In some embodiments, the prebiotic agent includes a yeast derivative.

The probiotics may include lactic acid-producing bacteria, live yeast cells, yeast culture, enzymes (protease and amylase), or a combination thereof.

The antimicrobial comprises monensin, bambermycin, lasalocid, salinomycin, a sesquiterpene, a terpene, an alkaloid, an essential oil, or their derivative thereof.

The antioxidant may include ethoxyquin (1,2-dihydro-6-ethoxy-2,2,4-trimethylquinoline), BHA (butylated hydroxyanisole), BHT (butylated hydroxytoluene), ascorbic acid, ascorbyl palmitate, benzoic acid, calcium ascorbate, calcium propionate, calcium sorbate, citrate acid, dilauryl thiodipropionate, distearyl thiodipropionate, erythorbic acid, formic acid, methylparaben, potassium bisulphite, potassium metabisulphite, potassium sorbate, propionic acid, propyl gallate, propyl paraben, resin guaiae, sodium ascorbate, sodium benzoate, sodium bisulphite, sodium metabisulphite, sodium nitrite, sodium propionate, sodium sorbate, sodium sulphite, sorbic acid, stannous chloride, sulphur dioxide, THBP (trihydroxy-butyrophenone), TBHQ (tertiary-butylhydroquinone), thiodipinic acid, tocopherols, polyphenol, carotenoid, flavonoids, flavones, quinones, anthracenes, or derivatives thereof.

The glucogenic precursor may include glycerol, propylene glycol, molasses, propionate, glycerine, propane diol, calcium or sodium propionate, polyol, molasses, vinasses, or its derivative thereof.

The vitamin may include at least one of vitamin A, vitamin B, vitamin C, vitamin D, vitamin H, vitamin E, vitamin K, or its derivative thereof. In some embodiments, the vitamin may include thiamine, riboflavin, niacin, pantothenic acid, pyridoxine, biotin, folic acid, cobalamin, carnitine, choline, or its derivative thereof.

The mineral may include any organic or inorganic salt. Representative minerals include a salt of calcium, sodium, magnesium, potassium, phosphorus, zinc, selenium, manganese, iron, cobalt, copper, iodine, molybdenum, an amino acid chelated mineral, an amino acid glycinated mineral, selenium yeast, an organic mineral chelate, an organic mineral glycinate, or a combination thereof. In some embodiments, the mineral is an organic mineral derivative. In some embodiments, the mineral comprises a sodium salt selected from monosodium phosphate, sodium acetate, sodium chloride, sodium bicarbonate, disodium phosphate, sodium iodate, sodium iodide, sodium tripolyphosphate, sodium sulfate, and sodium selenite. In some embodiments, the mineral comprises a calcium salt selected from calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, and tricalcium phosphate. In some embodiments, the mineral comprises a magnesium salt selected from magnesium acetate, magnesium carbonate, magnesium oxide, and magnesium sulfate. In some embodiments, the mineral comprises a cobalt salt selected from cobalt acetate, cobalt carbonate, cobalt chloride, cobalt oxide, and cobalt sulfate. In some embodiments, the mineral comprises a manganese salt selected from manganese carbonate, manganese chloride, manganese citrate, manganese gluconate, manganese orthophosphate, manganese oxide, manganese phosphate, and manganese sulfate. In some embodiments, the mineral comprises a potassium salt selected from potassium acetate, potassium bicarbonate, potassium carbonate, potassium chloride, potassium iodate, potassium iodide, and potassium sulfate. In some embodiments, the mineral comprises an iron salt selected from iron ammonium citrate, iron carbonate, iron chloride, iron gluconate, iron oxide, iron phosphate, iron pyrophosphate, iron sulfate, and reduced iron. In some embodiments, the mineral comprises a zinc salt selected from zinc acetate, zinc carbonate, zinc chloride, zinc oxide, and zinc sulfate. In some embodiments, the mineral comprises copper sulfate, copper oxide, selenium yeast, and a chelated mineral.

In some embodiments, choline may include choline derivatives. Choline derivatives can comprise choline chloride, choline bi-tartrate, di-hydrogenated citrate of choline, bicarbonate of choline, choline sulphate, choline hydroxide, or a combination thereof. In some embodiments, a choline precursor can comprise betaine or lecithin.

The rumen by-pass composition may provide a rumen by-pass feed ingredient for ruminant. The feed ingredient may be a carbohydrate material. In some embodiments, the feed ingredient may be a starch, wheat, corn, oat, barley, sorghum, millet, rapeseed meal, soybean meal, sunflower meal, cottonseed meal, camelina meal, mustard seed meal, crambe seed meal, safflower meal, rice meal, peanut meal, corn gluten meal, corn gluten feed, wheat gluten, distillers dried grains, distillers dried grains with solubles, blood meal, crab protein concentrate, fish meal, hydrolyzed poultry feather meal, soybean protein concentrate, sunflower seed meal, alfalfa residues, brewer's residues, poultry by-product meal, gluten feed, sunflower hulls, distillers grains, guar hulls, wheat middlings, rice hulls, rice bran, oilseed meals, animal byproduct meal, fish byproduct meal, dried fish solubles, feather meal, poultry byproducts, meat meal, bone meal, dried whey, soy protein concentrate, soy flour, yeast, wheat, oats, grain sorghum, corn feed meal, rye, aspirated grain fractions, brewers dried grains, corn flower, feeding oat meal, sorghum grain flour, wheat mill run, wheat red dog, hominy feed, wheat flower, wheat bran, wheat germ meal, oat groats, rye middlings, cotyledon fiber, algae meal, or ground grains. In some embodiments, the feed ingredient may be grain flour. In some embodiments, the feed ingredient is a gelatinized starch. In some embodiments, the feed ingredient is steamed grain flour. In some embodiments, the feed ingredient may be steamed corn.

The rumen by-pass composition may provide a rumen by-pass protein material for ruminant. The protein material may include rapeseed meal, soybean meal, sunflower meal, cottonseed meal, camelina meal, mustard seed meal, crambe seed meal, safflower meal, rice meal, peanut meal, corn gluten meal, corn gluten feed, wheat gluten, distillers dried grains, distillers dried grains with solubles, animal protein, or a combination thereof. In some embodiments, the protein material may include blood meal, crab protein concentrate, fish meal, hydrolyzed poultry feather meal, soybean meal, soybean protein concentrate, sunflower seed meal, cotton seed meal, corn gluten meal, alfalfa residues, brewer's residues, meat and bone meal, meat meal, rapeseed meal and poultry by-product meal, or a combination thereof. In some embodiments, the protein material comprises soybean meals, rapeseed meals, sunflower meals, coconut meals, olive meals, linseed meals, grapeseed meals, cottonseed meals, or mixtures thereof. In some embodiments, the protein material may include denatured protein. In some embodiments, the protein material may include cross-linked protein. In some embodiments, the protein material may include partially hydrolyzed protein.

The binding agent may include a synthetic or natural polymer, a polysaccharide or a protein. In some embodiments, the binding agent is a synthetic polymer. In some embodiments, the binding agent is a gelatinized starch.

The bulking agent may include silicate, kaolin, clay, a feed material, a carbohydrate material, a protein material or a combination thereof.

The filler may include a feed material. In some embodiments, the filler may include gluten feed, sunflower hulls, distillers grains, guar hulls, wheat middlings, rice hulls, rice bran, oilseed meals, dried blood meal, animal byproduct meal, fish byproduct meal, dried fish solubles, feather meal, poultry byproducts, meat meal, bone meal, dried whey, soy protein concentrate, soy flour, yeast, wheat, oats, grain sorghum, corn feed meal, rye, corn, barley, aspirated grain fractions, brewers dried grains, corn flower, corn gluten meal, feeding oat meal, sorghum grain flour, wheat mill run, wheat red dog, hominy feed, wheat flower, wheat bran, wheat germ meal, oat groats, rye middlings, cotyledon fiber, algae meal, and ground grains.

In some embodiments, the carrier may be a porous carrier material. In some embodiments, the porous carrier material comprises protein, grain, roughage, metal-organic framework, or a combination thereof.

In another aspect, the application provides methods for making the rumen by-pass compositions. The methods may include without limitation spray mixing, mixing with heating, coating, spraying coating, spin coating, prilling, encapsulation, or a combination thereof.

In a third aspect, the application provides systems for making the ruminant feed. The system may include a prilling tower, air-drying apparatus, spray coating apparatus, or a combination thereof.

In a further aspect, the application provides methods of increasing milk fat content of milk produced by a ruminant. In some embodiments, the method includes the steps of providing a rumen by-pass composition to the ruminant for ingestion; and collecting milk from the ruminant after the ruminant has ingested the ruminant feed mixture, wherein milk collected from the ruminant has a higher milk fat content, milk fat yield, milk protein content, or milk protein yield compared to milk before the ruminant ingested the ruminant feed mixture.

The ruminant may be a cow, goat, or sheep.

The application further provides methods for altering the concentration of milk solids in milk produced by a lactating mammal.

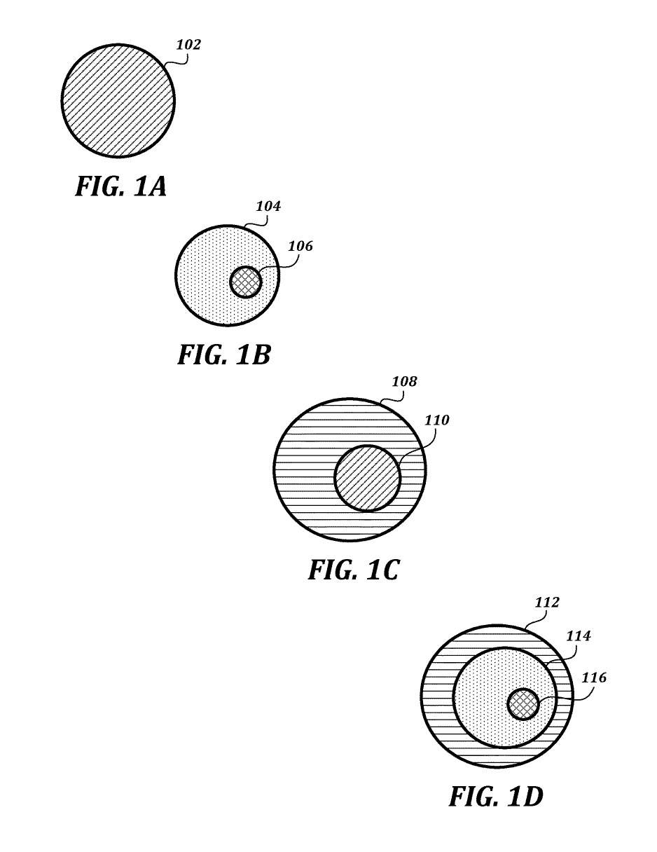

FIG. 1A is a diagrammatical illustration of homogeneous rumen by-pass composition 102 showing uniform distribution of the first rumen by-pass component and the nutritional composition throughout the rumen by-pass composition. The illustrated shape of the rumen by-pass composition is not limiting and can take other shapes depending, for example, on the manufacturing method.

FIG. 1B is a diagrammatical illustration of heterogeneous rumen by-pass composition showing a non-uniform distribution of the first rumen by-pass component and the nutritional composition. In the embodiment illustrated, the nutritional composition is shown as a core 106 and the first rumen by-pass component is shown as a shell 104. The rumen by-pass composition of FIG. 1B can be made for example, by encapsulation methods. The illustrated shape of the rumen by-pass composition is not limiting and can take other shapes depending, for example, on the manufacturing method.

FIG. 1C is a diagrammatical illustration of a heterogeneous rumen by-pass composition showing a non-uniform distribution of the first rumen by-pass mixture 110 and the second rumen by-pass component 108. In some embodiments, the mixture is a homogeneous mixture of the first rumen by-pass component and the nutritional composition. In some embodiments, the mixture is a heterogeneous mixture of the first rumen by-pass component and the nutritional composition. In the embodiment illustrated, the first rumen by-pass mixture is shown as a core 110 and the second rumen by-pass component is shown as a shell 108. The rumen by-pass composition of FIG. 1C can be made for example, by encapsulation methods. The illustrated shape of the rumen by-pass composition is not limiting and can take other shapes depending, for example, on the manufacturing method.

FIG. 1D is a diagrammatical illustration of a heterogeneous rumen by-pass composition showing a non-uniform distribution of the first rumen by-pass component, the second rumen by-pass component, and the nutritional composition. In the embodiment illustrated, the nutritional component is the core 116, the first rumen by-pass component 114 is encapsulated over the core 116, and the second rumen by-pass component 112 is shown as a shell 112 that encapsulates the first rumen by-pass component 114. The rumen by-pass composition of FIG. 1D can be made for example, by encapsulation methods. The illustrated shape of the rumen by-pass composition is not limiting and can take other shapes depending, for example, on the manufacturing method.

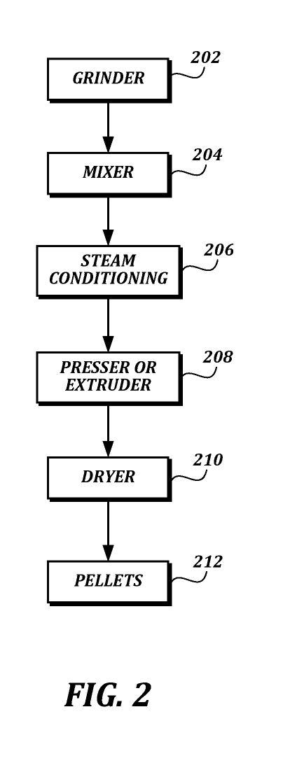

FIG. 2 is a schematic illustration of a system and method of making some embodiments of the rumen by-pass compositions. The system of FIG. 2 may be used to make the homogeneous rumen by-pass compositions or the cores of the rumen by-pass compositions, for example. In some embodiments, the system can include a grinder, block 202. Following the grinder, block 202, the system may include a mixer, block 204. The mixer, block 204, can include a paddle mixer or a ribbon mixer. In some embodiments, the system includes a steam conditioning vessel, block 206, in communication with the first mixer, block 204. In some embodiments, following the steam conditioning vessel, the system can include a pellet presser, expander, or extruder, block 208, in communication with the steam conditioning vessel, block 206. In some embodiments, a dryer, block 210 follows the pellet presser, expander, or extruder. The method and system of FIG. 2 can create pellet-shaped rumen by-pass compositions.

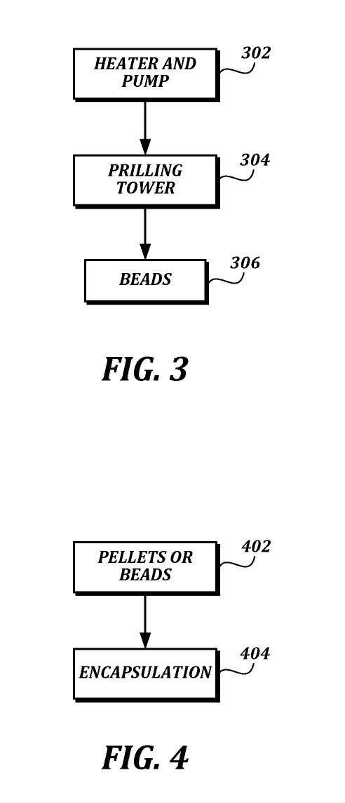

FIG. 3 is a schematic illustration of a system and method of making embodiments of the rumen by-pass compositions. One embodiment of the method employed for making the compositions is referred to as “prilling.” Prilling, also called “spray chilling,” “spray cooling,” or “spray congealing,” generally refers to a process of spraying droplets through nozzles and allowing droplets to congeal in mid-air as they fall from the top of a prilling tower toward a collection surface. Air may be circulated upward through the tower to aid in congealing the droplets into a solid. The size and shape of the droplets may be affected by the height of the tower, the nozzle size, and the nozzle shape. For example, larger sized droplets may require a higher tower than smaller sized droplets. The droplets tend to congeal without agglomerating, and the surface tension of the liquid droplets results in a generally rounded bead surface. In some embodiments, the beads may be round or oval shaped. The system of FIG. 3 may be used to make the homogeneous rumen by-pass compositions or the cores of the rumen by-pass compositions, for example.

The nutritional component or the first rumen by-pass mixture, herein described, is heated to the melting temperature using a heater, block 302. The temperature leaving the heater can be at or slightly above the melt temperature. The melt can be pumped via a pump, block 302. Then, the melt is distributed through a droplet-producing device at the top of the prilling tower, block 304. As the droplets fall in the tower, the droplets will congeal and solidify by the time they reach the bottom of the tower as solid beads, block 306.

FIG. 4 is a schematic illustration of a system and method of encapsulation. In some embodiments, the beads or pellets, block 402, produced by the methods of FIGS. 2 and 3 may be further encapsulated with an encapsulation process, block 404. In some embodiments, the encapsulated rumen by-pass compositions may be manufactured with an encapsulation prilling process, block 404, in which the core material and the shell material are sprayed from different nozzles. In some embodiments, the rumen by-pass composition may be encapsulated with a curtain coating process. Other example encapsulation processes, block 404, may include, without limitation, extrusion, co-extrusion, pan coating, fluidized bed, and coacervation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, recompositions, compounds, compositions or biological systems, which can, of course, vary. It is also to be understood that the terminology used herein is for the purpose of describing particular embodiments only, and is not intended to be limiting.

With respect to the use of plural, singular, or both herein, those having skill in the art can translate from the plural to the singular, from the singular to the plural, or both as is appropriate to the context. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). In those instances where a convention analogous to “at least one of A, B, or C, et cetera” is used, in general such a construction is intended in the sense one having skill in the art would understand the convention (for example, “ a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or FIGURES, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

While illustrative embodiments have been illustrated and described, it will be appreciated that various changes can be made therein without departing from the spirit and scope of the invention.

The embodiments of the invention in which an exclusive property or privilege is claimed are defined as follows:

1. A rumen by-pass composition, comprising a first rumen by-pass component and a nutritional composition, wherein the first rumen by-pass component comprises a first fatty acid composition having a melting point not less than 40° C. and an Iodine Value not greater than 30.

2. The rumen by-pass composition of claim 1, wherein the nutritional composition is configured to substantially bypass rumen when administered to a ruminant.

3. The rumen by-pass composition of claim 1, wherein the first rumen by-pass component is configured to protect the nutritional composition from rumen bacterial metabolism.

4. The rumen by-pass composition of claim 1, wherein the rumen by-pass composition is formed as solid particles.

5. The rumen by-pass composition of claim 1, wherein the first rumen by-pass component and the nutritional composition form a homogeneous mixture.

6. The rumen by-pass composition of claim 1, wherein the first rumen by-pass component and the nutritional composition form a heterogeneous mixture.

7. The rumen by-pass composition of claim 6, wherein the first rumen by-pass component at least partially encapsulates the nutritional composition.

8. The rumen by-pass composition of claim 1, wherein the first rumen by-pass component has a melting point not less than 50° C.

9. The rumen by-pass composition of claim 1, wherein the first rumen by-pass component further comprises a wax.

10. The rumen by-pass composition of claim 1, wherein the first rumen by-pass component further comprises a polymer.

11. The rumen by-pass composition of claim 1, further comprising a filler, an antistatic agent, a plasticizer, a colorant, an appetite stimulant, a flavoring agent, a surfactant, or a combination thereof.

12. The rumen by-pass composition of claim 11, wherein the filler comprises a feed ingredient.

13. The rumen by-pass composition of claim 1, wherein the first fatty acid composition has a melting point from about 54° C. to about 200° C.

14. The rumen by-pass composition of claim 1, wherein the first fatty acid composition has an Iodine value from about 0.5 to about 6.

15. The rumen by-pass composition of claim 1, wherein the first fatty acid composition has unsaponifiable matter no greater than 1.5% by weight.

16. The rumen by-pass composition of claim 1, wherein the first fatty acid composition comprises a palmitic acid compound.

17. The rumen by-pass composition of claim 16, wherein the first fatty acid composition comprises at least 98% of free palmitic acid by weight.

18. The rumen by-pass composition of claim 1, wherein the first fatty acid composition comprises a stearic acid compound.

19. The rumen by-pass composition of claim 1, wherein the first fatty acid composition consists essentially free palmitic acid, free stearic acid, or a combination thereof.

20. The rumen by-pass composition of claim 1, further comprising a second rumen by-pass component.

21. The rumen by-pass composition of claim 20, wherein the second rumen by-pass component comprises a second fatty acid composition having a melting point not less than 40° C. and an Iodine Value not greater than 10.

22. The rumen by-pass composition of claim 20, wherein the first rumen by-pass component and the nutritional composition forms a first rumen by-pass mixture, and wherein the second rumen by-pass component at least partially encapsulates the first rumen by-pass mixture.

23. The rumen by-pass composition of claim 1 having a core component and a shell component at least partially encapsulating the core component, wherein the core component comprises the nutritional composition; and wherein the shell component comprises the first rumen by-pass component.

24. The rumen by-pass composition of claim 20, having a first core component, a first shell component at least partially encapsulating the first core component to provide a second core component, and a second shell component at least partially encapsulating the second core component, wherein the first core component comprises the nutritional composition; wherein the first shell component comprises the first rumen by-pass component; and wherein the second shell component comprises the second rumen-by pass component.

25. The rumen by-pass composition of claim 1, wherein the nutritional composition comprises an amino acid compound, a lipid, a vitamin, a trace element, a mineral, a glucogenic precursor, an antioxidant, a prebiotic agent, a probiotic agent, an antimicrobial agent, an enzyme, a choline derivative, a feed ingredient, a carrier, a binding agent, a bulking agent, or a combination thereof.

26. The rumen by-pass composition of claim 25, wherein the amino acid compound comprises leucine, lysine, histidine, valine, arginine, threonine, isoleucine, phenylalanine, methionine, tryptophan, carnitine, alanine, asparagine, lysine, aspartic acid, cysteine, glutamic acid, glutamine, glycine, valine, ornithine, proline, selenocysteine, selenomethionine, serine, tyrosine, its derivative or precursor thereof.

27. The rumen by-pass composition of claim 25, wherein the amino acid compound comprises a methionine compound or a lysine compound.

28. The rumen by-pass composition of claim 27, wherein the methionine compound comprises methionine, methionine HCl salt, methionine HBr salt, methionine HI salt, N-steroyl-methionine, Oleoyl-methionine, capryl-capryolic methionine, methionine ethyl ester, methionyl DL-methionine, N-t-butyloxycarbonyl-L-methionine-do-cyclohexyl ammonium salt, N-t-butyloxycarbonyl-L-methionine-p-nitrophenyl ester, N-propionyl-DL-methionine, N-carbobenzoxy-DL-methionine, 3-benzoyloxydihydro-2(3H)thiophenone, glycyl-DL-methionine, N-acetyl-DL-methionine, N-formyl-DL-methionine poly-L-mehtionine, methionine hydroxyl analog methyl ester, 3-hydroxydihydro-2(3H)thiophenone, phenyl-r-methyl mercapto-a-hydroxybutyrate, methionine sulfoxide, DL-methionine amide HCl, DL-methionine sulfone, DL-methionine methyl ester HCl, DK-2-ureido-4-methylthiobutyric acid, N-acetyl-DL-homocysteine thiolactone, N-formyl-DL-methionine, DL-methione, N-benzoyl-DL-methionine amide, N-benzoyl-DL-methionine methyl ester, DL-methionine methyl sulfonium chloride, DL-homocysteine, N-octanoyl-DL-methionine, N-lauryl-DL-methionine, N-lauryl-DL-homocysteine thiolactone, N-benzoyl-DL-homocysteine thiolactone, N-lauryl-DL-methionine methyl ester, DL-homocysteine thiolactone hydrochloride, N-hydroxylmethyl-DL-methionine Ca, and a derivative thereof.

29. The rumen by-pass composition of claim 27, wherein the lysine compound comprises lysine, lysine HCl salt, lysine HBr salt, lysine HI salt, dyhydroxymethyl-L-lysine-Ca, polylysine, or a derivative thereof.

30. The rumen by-pass composition of claim 25, wherein the lipid comprises one or more oils, fats, esters, monoglycerides, diglycerides, triglycerides, or free fatty acids.

31. The rumen by-pass composition of claim 30, wherein the lipid comprises an essential fatty acid.

32. The rumen by-pass composition of claim 30, wherein the lipid comprises essentially conjugated linoleic acid.

33. The rumen by-pass composition of claim 30, wherein the lipid comprises alpha-linolenic acid, an omega-3 fatty acid, or an omega-6 fatty acid.

34. The rumen by-pass composition of claim 30, wherein the lipid comprises oleic acid or an oleic derivative.

35. The rumen by-pass composition of claim 34, wherein the oleic derivative comprises an oleic acid ester, a high oleic oil, or a combination thereof.

36. The rumen by-pass composition of claim 35, wherein the high oleic oil comprises at least 40% by weight of oleic content.

37. The rumen by-pass composition of claim 25, wherein the vitamin comprises vitamin A, vitamin B, vitamin C, vitamin D, vitamin H, vitamin E, vitamin K, or its derivative thereof.

38. The rumen by-pass composition of claim 25, wherein the choline derivative comprises choline, choline chloride, choline bi-tartrate, di-hydrogenated citrate of choline, bicarbonate of choline, choline sulphate, choline hydroxide, or a combination thereof.

39. The rumen by-pass composition of claim 1, further comprising a surfactant component.

40. The rumen by-pass composition of claim 39, wherein the surfactant component comprises a non-ionic emulsifier.

41. The rumen by-pass composition of claim 39, wherein the surfactant component comprises an ionic emulsifier.

42. The rumen by-pass composition of claim 39, wherein the surfactant component comprises an emulsifier having a hydrophilic-lipophilic balance value of about 5 to about 25.

43. The rumen by-pass composition of claim 39, wherein the surfactant component comprises polyoxyethylene stearate, polysorbate, polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate, ammonium phosphatides, sodium or potassium or calcium salts of fatty acids, magnesium salts of fatty acids, mono- and diglycerides of fatty acids, acetic acid esters of mono- and diglycerides of fatty acids, lactic acid esters of mono- and diglycerides of fatty acids, citric acid esters of mono- and diglycerides of fatty acids, mono- and diacetyl tartaric acid esters of mono- and diglycerides of fatty acids, acetic acid esters of mono- and diglycerides of fatty acids, tartaric acid esters of mono- and diglycerides of fatty acids, sucrose esters of fatty acids sucroglycerides, polyglycerol esters of fatty acids polyglycerol polyricinoleate, propane-1,2-diol esters of fatty acids, thermally oxidised soya bean oil interacted with mono- and diglycerides of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, or derivatives thereof.

44. The rumen by-pass composition of claim 39, wherein the surfactant component comprises a surfactant derived from oleic acid.

45. The rumen by-pass composition of claim 39, wherein the surfactant component comprises sodium oleate, potassium oleate, calcium oleate, ammonium oleate, sorbitan oleate, sorbitan trioleate, glyceryl oleate, methyl oleate, ethyl oleate, PEG oleate, triethanolamine oleate (TEA oleate), polysorbitan oleate, polysorbate 20, polysorbate 40, polysorbate 60, polysorbate 80, or a combination thereof.

46. A dietary composition for ruminants, comprising the rumen by-pass composition of anyone of claims 1-45 and a feed ingredient.

47. The dietary composition of claim 46, wherein dietary composition is formed as a mash mixture, granules, particles, or pellets.
